(19) United States
(12) Patent Application Publication
(10) Pub. No.: US 2026/0301478 A1
(43) Pub. Date: Oct. 1, 2026

(54) AUTONOMOUS AGRICULTURAL WORK MACHINE

(71) Applicant: CLAAS Tractor SAS, Vélizy-Villacoublay Cedex (FR)

(72) Inventors: Tobias NIGGEMEYER, Paderborn (DE); Robin MONKENBUSCH, Rheda-Widenbrück (DE); Thiebaud RUSTERHOLTZ, Limours (FR)

(21) Appl. No.: 19/578,484

(22) Filed: Mar. 25, 2026

(30) Foreign Application Priority Data
Mar. 25, 2025 (DE) 10 2025 111 803.5

(51) Int. Cl. G07C 5/02; A01B 69/04; A01B 76/00; G07C 5/00

(52) U.S. Cl. CPC G07C 5/02; A01B 69/008; A01B 76/00; G07C 5/006

(57) ABSTRACT

The present invention relates to an autonomous agricultural work machine with at least one adaptation device for connecting an attachment to the machine and with a sensor device comprising several sensors, which is designed to determine data (BD, PD) of the autonomous work machine and the connected attachment, which comprise operating parameters of the autonomous work machine and/or the attachment, and to supply the data (BD, PD) to a control device which is designed to evaluate the data (BD, BD) determined by the sensor device, wherein the control device has a function control unit which is designed to check a respective operating state of the autonomous work machine and/or the attachment before, during and after the performance of an agricultural task, wherein the determination of the respective operating state is based on an evaluation of status information which is based on an analysis of the data (BD, PD) provided by the sensor device before, during and after the performance of the agricultural task.

### CROSS-REFERENCE TO RELATED APPLICATIONS

This application claims priority to German Patent Application No. 10 2025 111 803.5 (filed Mar. 26, 2025), the disclosure of which is incorporated by reference in its entirety.

### FIELD OF THE INVENTION

The present invention relates to an autonomous agricultural work machine having at least one adaptation device for connecting an attachment to the machine and with a sensor device comprising several sensors, which is designed to determine data (e.g. image data (BD) or physical data (PD)) of the autonomous work machine and the connected attachment, and a control device for controlling the operation of the work machine.

### BACKGROUND OF THE INVENTION

DE 10 2022 110 130 A1 discloses an autonomous agricultural work machine of the type mentioned above. To operate the autonomous agricultural work machine with at least one adaptation device for connecting an attachment to the machine, it is provided that data from the autonomous work machine and the connected attachment are determined by a sensor device comprising several sensors. The data comprises operating parameters of the autonomous work machine and/or attachment, which are provided by the sensor device of a control device for evaluation. Based on the evaluation of the data collected, the control device determines the occurrence of an irregularity, which may be a defective working unit of the working machine, a defective attachment, or an obstacle on the route to be traveled by the working machine. In response to the occurrence of an irregularity, the first step is to transfer the autonomous work machine to a safe operating state, regardless of the type of irregularity, in which the operation of the autonomous work machine is interrupted. In the second step, the type of irregularity is determined in order to generate an instruction to transfer the autonomous work machine from the safe operating state to a normal operating state, depending on the identified irregularity.

Based on the aforementioned state of the art, the invention is based on the task of further developing an autonomous agricultural work machine of the type mentioned at the outset, which is characterized by an extended monitoring function of the autonomous work machine and an attachment adapted to it.

### SUMMARY OF THE INVENTION

The above task is solved by an autonomous agricultural work machine having at least one adaptation device for connecting an attachment to the machine and with a sensor device comprising several sensors, which is designed to determine data (e.g. image data (BD) or physical data (PD)) of the autonomous work machine and the connected attachment, and a control device for controlling the operation of the work machine based on the data.

According to some embodiments, an autonomous agricultural work machine with at least one adaptation device for connecting an attachment to the machine is proposed. The work machine has a sensor device comprising several sensors, which is designed to determine data from the autonomous work machine and the connected attachment, including operating parameters of the autonomous work machine and/or the attachment, and to provide the data to a control device that is designed to evaluate the data determined by the sensor device. According to the invention, the control device is provided with a function control unit which is designed to monitor a respective operating state of the autonomous work machine and/or the attachment before, during, and after performing an agricultural task, wherein the determination of the respective operating state is based on an evaluation of status information which is based on an analysis of the data provided by the sensor device before, during, and after performing the agricultural task.

The invention is based on the idea that a faulty or irregular operating state, which leads to the prevention of the commencement of an agricultural task, an interruption during the performance of the agricultural task, or an unsafe operating situation after the performance of the agricultural task, is detected at the earliest possible time. The status information comprises at least the data provided by the sensor device that is available for the attachment, the at least one adaptation device, and/or the attachment.

The at least one adaptation device may be designed and configured for mechanical, electrical, electromechanical, pneumatic, hydraulic, and/or communicative connection of the attachment. In particular, several different adaptation devices may be provided for connecting the attachment.

Preferably, the function control unit can be set up to retrieve and take into account environmental data as status information from an external data source when determining the respective operating state. Environmental data includes weather data such as precipitation, wind direction, and wind speed, and/or data on soil conditions and topographical data such as terrain slope.

In particular, the data provided by the sensor device may include physical data and image data generated before, during, and after the performance of the work task. For this purpose, the sensor device may comprise several different sensors that are designed and configured to capture physical data and image data. The sensors for recording physical data can be designed, for example, as torque sensors, speed sensors, vibration sensors, proximity sensors, force sensors, acceleration sensors, acoustic sensors, position sensors, and/or humidity sensors. The sensors for capturing the image data are designed as optical sensors, preferably as cameras.

The physical data may be from the group of acoustic data, vibration data and/or torque data, throughput data, pressure data, angle of inclination data and/or movement data of the working machine, the at least one adaptation device and/or the attachment, for the detection of which a part of the sensors of the sensor device is set up and designed. Throughput data can be mass flows and/or volume flows that can be detected by sensors on the working machine and/or attachment.

The image data may comprise images of the working machine, the at least one adaptation device, the connected attachment, and the environment, which are generated by some of the sensors of the sensor device before, during, and after the working machine performs the work task. For this purpose, the sensor device may comprise at least one camera which is designed and configured to generate image data of the working machine, the at least one adaptation device, the connected attachment, and the environment. Preferably, the sensor device comprises several cameras.

The function control unit may preferably be set up to perform a function check of the sensors, the working machine, the at least one adaptation device, and the attachment and/or a check of the connection status of the attachment to the adaptation device before performing an agricultural task. For this purpose, the function control unit can be set up and programmed to send status queries to the sensors, to working units, and/or to one or more control units of the working machine, the at least one adaptation device, and/or the attachment. Status queries can be transmitted by the function control unit via a wired bus system and/or wirelessly.

According to a further embodiment, the function control unit can be set up to perform a function check of connections of the at least one adaptation device, which are designed as hydraulic connections, pneumatic connections, electrical connections, and/or communication connections, after the attachment has been connected to the at least one adaptation device. For this purpose, the function control unit can be set up and programmed to generate control commands that are used to control components connected to the hydraulic connections, pneumatic connections, electrical connections, and/or communication connections. Alternatively or additionally, image data of at least one adaptation device can be provided to the function control unit of at least one sensor of the sensor device for evaluation, which reproduces the connections of at least one adaptation device and their assignment.

In particular, the function control unit may be configured to monitor compliance with an operating position of the attachment and components arranged on the attachment during the performance of an agricultural task and/or to monitor an operating sequence of the attachment and the components arranged on the attachment.

Preferably, the function control unit can be set up to check the operating position and/or the operating sequence by comparing it with images and/or video sequences stored in a memory unit. The images and/or video sequences can show a target operating position and/or a target operating sequence for this purpose. This allows, for example, attachments that are in a transport position prior to commissioning for the performance of the work task to be checked. The transport position can be achieved by folding and/or folding individual segments of the attached attachment. This can apply equally to attachments designed as front-mounted implements for harvesting crops and to attachments designed as soil cultivation implements or implements for applying fertilizers or plant protection products. Using the image data and/or video sequences stored in the memory unit, it is possible to check, by comparing them with the recorded image data and/or video sequences provided by the sensor device, whether the attachment has assumed its intended operating or working position as its operating position and maintains this position while performing the agricultural task.

According to a further embodiment, the function control unit can be set up to monitor the transfer of the autonomous agricultural work machine to a safe operating state after completion of the agricultural task and to ensure that the safe operating state is maintained. Transitioning to a safe operating state may include lifting the attachment to raise it off the ground, moving it to its transport position, switching off drive devices for driving or operating working units of the autonomous work machine and/or the attachment, and/or moving the autonomous work machine to a designated position on or at the edge of a territory to be worked.

The function control unit may preferably be set up to check that the autonomous agricultural work machine is in a safe operating state and that it remains in a safe operating state by comparing it with images and/or video sequences stored in the memory unit. The images and/or video sequences can reproduce a safe target operating state, which is compared with the image data provided by the sensor device.

In particular, the function control unit can be set up to control the working machine in order to move it into a service position or a pick-up position on or at the edge of a processed or to-be-processed area as a safe operating state.

The function control unit may be configured to issue warnings depending on the operating state. In this context, “operating state dependent” means that before, during, or after the performance of the agricultural task, an operating state determined by the function control unit occurs which prevents the start of the agricultural task, causes an interruption during the performance of the agricultural task, or leads to an unsafe operating situation after the performance of the agricultural task.

For example, if a faulty connection of ports on at least one adaptation device is detected during the check prior to performing the agricultural task, a corresponding warning can be issued. Such incorrect attachment means that it is not possible to perform the agricultural task and/or damage may occur to the machine, the at least one adaptation device, and/or the attachment.

In addition, the warning may include information containing instructions for correction and/or guidance on correct usage. Another example could be the detection of incomplete engagement of the operating position of the attachment. An operating state that occurs during operation and triggers a warning could be, for example, a loss of pressure in the hydraulic or pneumatic system. Another example of an operating state that occurs during the performance of agricultural work and generates a warning is the detachment of a connection hose or connecting line. In general, a warning can be issued if one of the sensors in the sensor device fails.

According to a further embodiment, the function control unit can be set up to issue maintenance instructions based on the evaluation of status information, regardless of the operating state. Operating state-independent means that all operating situations before, during, and after the agricultural task is performed are included, in which maintenance instructions can be generated based on the evaluation of the status data. Unlike warnings, which are caused by a faulty or irregular operating state detected by the function control unit, maintenance instructions are recommendations for maintaining the long-term operational readiness of the machine, at least one adaptation device, and/or the attachment.

For example, generated maintenance instructions may relate to fuel levels, auxiliary or operating materials, and the like. It is also conceivable to detect wear on components of the attachment, at least one adaptation device, and/or the working machine and to provide associated maintenance instructions. In particular, environmental data can also be evaluated as operating state-independent status data. An example of this is the occurrence of a change in weather.

Operating state-dependent warnings or operating state-independent maintenance instructions can be issued via a remote stationary or mobile display device. For this purpose, the display device may be connected to the control device for data transmission.

The function control unit can be configured to monitor and document process progress independently of the operating state. This enables subsequent evaluation of the processes before, during, and after the agricultural task has been carried out. Furthermore, the recorded and documented progress of the process can be transmitted to third parties. This may be done for verification and billing purposes, for example.

Furthermore, the function control unit may preferably comprise an image evaluation module which is designed to analyze the image data using a machine learning algorithm. Preferably, the machine learning algorithm may comprise at least one trainable neural network for analyzing the image data. This is advantageous if the operating position and/or the operating sequence are checked by comparing them with images and/or video sequences stored in a memory unit. The analysis of image data using the machine learning algorithm can also be used to check that the attachment is in a safe operating state and to monitor compliance. The safe operating state can also be checked by comparing it with images and/or video sequences stored in the memory unit that reflect the safe target operating state.

Other features and advantages of the invention will be apparent from the detailed description and examples that follow.

### BRIEF DESCRIPTION OF THE DRAWINGS

The foregoing summary, as well as the following detailed description of the invention, will be better understood when read in conjunction with the appended figures. For the purpose of illustrating the invention, the figures demonstrate embodiments of the present invention. It should be understood, however, that the invention is not limited to the precise arrangements, examples, and instrumentalities shown.

The present invention will be explained in more detail below with reference to an exemplary embodiment shown in the drawings.

The following is shown in the figures below:

FIG. 1 schematically and exemplarily shows an autonomous agricultural work machine performing an agricultural task;

FIG. 2 schematically and exemplarily shows a partial view of an autonomous work machine designed as a tractor, which is connected to an attachment designed as a baler; and

FIG. 3 schematically and exemplarily shows a representation of a front area of a cabin of the autonomous work machine according to FIG. 2 with sensors of a sensor device.

### DETAILED DESCRIPTION

The general description and the following detailed description are exemplary and explanatory only and are not restrictive of the invention, as defined in the appended claims. Other aspects of the present invention will be apparent to those skilled in the art in view of the detailed description of the invention as provided herein.

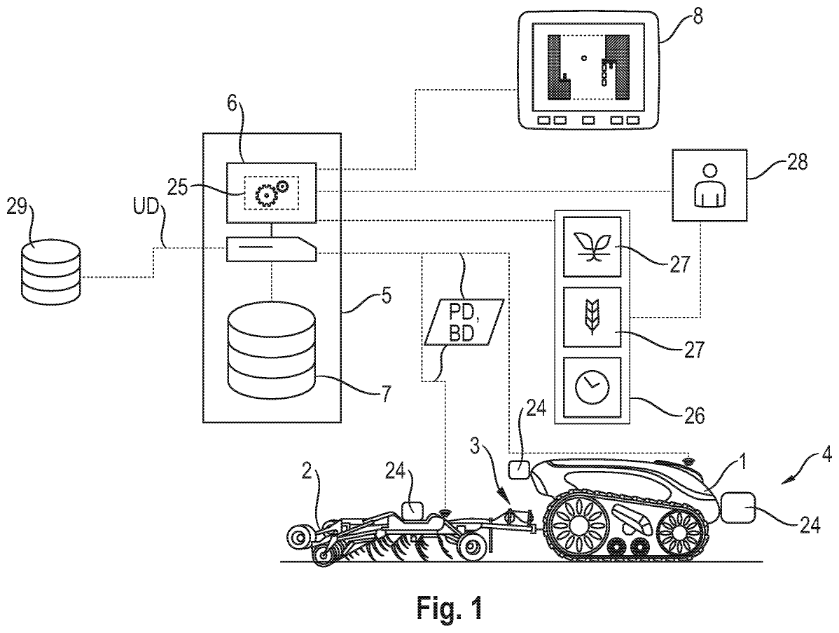

FIG. 1 schematically and exemplarily shows an autonomous agricultural work machine 1 performing an agricultural task 27, for example soil cultivation, in a field. To perform agricultural task 27, an attachment 2 is adapted to the autonomous work machine 1, in the exemplary embodiment shown, a cultivator.

The autonomous work machine 1 has at least one adapter 3 for connecting the attachment 2. The at least one adaptation device 3 may be designed as a hydraulic power lift 10 and/or as a power take-off (PTO) shaft. The autonomous work machine 1 has a sensor device 4 that is designed to determine data from the autonomous work machine 1 and the connected attachment 2, which includes operating parameters of the autonomous work machine 1 and/or the attachment 2. The data determined by the sensor device 4 is provided to a control device 5, which is set up to evaluate the data determined by the sensor device 4. The control device 5 comprises a computing unit 6 and a memory unit 7. The control device 5 is connected to a remote display device 8. The display device 8 may be stationary or mobile. Sensors 24 of the sensor device 4 are arranged at various positions on the autonomous work machine 1 and on the attachment 2. The positions of the sensors 24 shown are merely examples and may differ from the arrangement shown due to the sensor technology used for individual sensors 24.

The at least one work task 27 to be performed by the autonomous work machines 1 can be transmitted by an operator 28 to the control device 5 via a user interface 26. Preferably, the user interface 26 may comprise the display device 8.

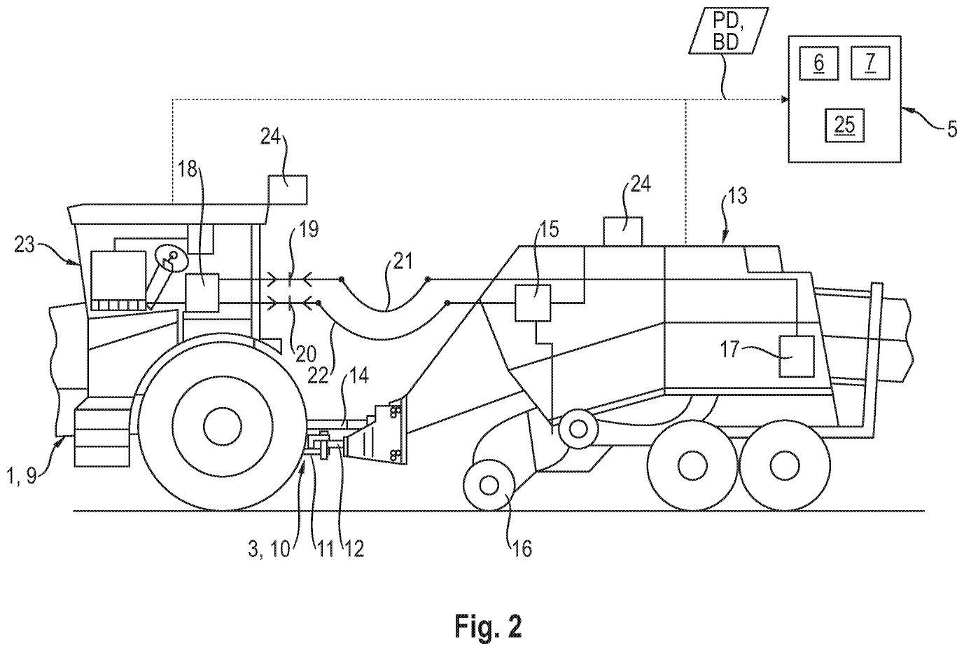

FIG. 2 shows an autonomous work machine 1 designed as a tractor 9. The tractor 9 picks up a drawbar 12 of an attachment 2 designed as a baler 13 at the rear of the tractor on liftable and lowerable lower links 11 of an adaptation device 3 designed as a hydraulic power lift 10. The baler 13 is driven by means of a drive shaft 14 as an adaptation device 3 from a PTO shaft of the tractor 9, which is not shown in detail, and features, among other things, a pick-up 16 that can be adjusted via a hydraulic adjustment device 15, as well as a conveyor channel for harvested material that can be adjusted via a further adjustment device 17 and is not shown in detail. A hydraulic control device 18 is connected to a pressure medium source and preferably consists of a block of several hydraulic directional control valves that are electromagnetically pilot-controlled. The rear section of the tractor 9, i.e., in the area of its power lift 10, is provided with several coupling elements, of which in the present case two coupling elements 19 and 20 designed as remote connections are connected via pairs of connecting lines 21 and 22 designed as pressure medium hoses to the aforementioned hydraulic adjustment devices 15 and 17 respectively. The coupling elements 19 and 20 form a further adaptation device 3 of the autonomous work machine 1 and the tractor 9, respectively.

The at least one adaptation device 3 may, in addition to being designed, for example, as a hydraulic power lift 10, the PTO shaft, and the drive shaft 14, also comprise connections or be designed as such, which are designed as hydraulic connections, pneumatic connections, electrical connections, and/or communication connections.

The at least one adaptation device 3 can thus be designed and set up for the mechanical, electrical, electromechanical, pneumatic, hydraulic, and/or communicative connection of the attachment 2 to the autonomous work machine 1. In particular, several different adaptation devices 3 may be provided for connecting the attachment 2 to the autonomous work machine 1.

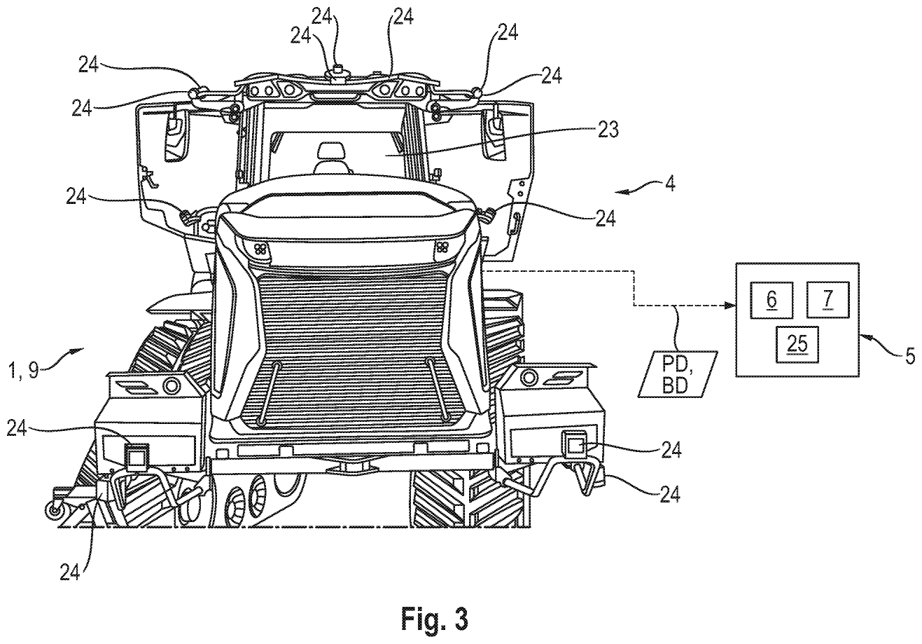

FIG. 3 shows a schematic and exemplary representation of the front area of a cabin 23 of the autonomous work machine 1 according to FIG. 2 with several sensors 24 of the sensor device 4. Additional sensors 24 are arranged in the rear area of the cabin 23, as shown in FIG. 2.

The control device 5 has a function control unit 25 which is designed to monitor a respective operating state of the autonomous work machine 1 and/or the attachment 3 before, during, and after the performance of an agricultural work task 27, wherein the determination of the respective operating state is based on an evaluation of status information which is based on an analysis of the data provided by the sensor device 4 before, during, and after the performance of the agricultural work task 27.

The function control unit 25 is designed to retrieve and take into account environmental data UD as status information from an external data source 29 when determining the respective operating state. Environmental data UD includes weather data such as precipitation, wind direction, and wind speed, and/or data on soil conditions and topographical data such as terrain slope.

The data provided by the sensor device 4 comprises physical data PD and image data BD. The physical data PD can be from the group of acoustic data, vibration data and/or torque data, pressure data, throughput data, inclination angle data and/or movement data of the working machine 1, the at least one adaptation device 3 and/or the attachment 2, for the detection of which a part of the sensors 24 of the sensor device 4 is designed and constructed. Sensor-determined throughput data may relate, for example, to crop throughputs, consumption quantities of operating materials and/or auxiliary materials, or the like.

The image data BD may comprise images of the working machine 1, the at least one adaptation device 3, the connected attachment 2, and the environment, which are generated by some of the sensors 24 of the sensor device 4 before, during, and after processing by the autonomous work machine 1. For this purpose, the sensor device 4 may comprise at least one camera which is designed and configured to generate image data BD of the working machine 1, the at least one adaptation device 3, the connected attachment 2, and the environment. Preferably, the sensor device 4 comprises several cameras.

The function control unit 25 provides an extended monitoring function for the autonomous work machine 1, the attachment 2 adapted thereto, and at least one adaptation device 3, covering the periods before, during, and after the performance of the agricultural task 27.

The function control unit 25 is designed to perform a function check of the sensors 24, the working machine 1, the at least one adaptation device 3, and the attachment 2, and/or to check the connection status of the attachment 2 to the at least one adaptation device 3 before performing an agricultural task 27. For this purpose, the function control unit 25 can be set up and programmed to send status queries to the sensors 24, to working units and/or to one or more control units of the working machine 1, the at least one adaptation device 3 and/or the attachment 2. Status queries can be transmitted by the function control unit 25 via a wired bus system and/or wirelessly.

For example, the function control unit 25 can transmit status queries to the hydraulic control device 18 as a control unit of the working machine 1 in order to check its operational readiness. On the other hand, the function control unit 25 can transmit status queries to the hydraulic control device 18 in order, for example, to check the assignment of the connecting lines 21 and 22 to the coupling elements 19 and 20.

Similarly, the function control unit 25 can transmit status queries to the various sensors 24 of the sensor device 4 in order to check their operational readiness.

Furthermore, the function control unit 25 is designed and programmed to perform a function check of connections of the at least one adaptation device 3, which are designed as hydraulic connections, pneumatic connections, electrical connections, and/or communication connections, after the attachment 2 has been connected to the adaptation device 3. The function check is performed immediately after the attachment 2 is connected to the adaptation device 3 in order to detect any incorrect assignments before the work task 27 is started.

During the performance of an agricultural task 27, the operating position of the attachment 2 and of components arranged on the attachment 2 is monitored and/or a check of the operating sequence of the attachment 2 and of the components arranged on the attachment 2 is performed by the function control unit 25.

For this purpose, the function control unit 25 can be set up and programmed to check the operating position and/or operating sequence by comparing it with images and/or video sequences stored in the memory unit 7, which represent a target operating position and/or a target operating sequence.

Preferably, the function control unit 25 may comprise an image evaluation module which is set up to analyze the image data BD by means of a machine learning algorithm. Preferably, the machine learning algorithm may comprise at least one trainable neural network for analyzing the image data BD. This is advantageous if the operating position and/or the operating sequence is or are checked by comparison with images and/or video sequences stored in the memory unit 7.

Furthermore, the function control unit 25 is designed to monitor the transfer of the autonomous agricultural work machine 1 to a safe operating state after completion of the agricultural task 27 and to monitor compliance with the safe operating state that has been adopted. The transition to the safe operating state and compliance with it can also be checked by comparing it with images and/or video sequences stored in memory unit 7 that show the safe target operating state to be assumed.

If a faulty or irregular operating state occurs before, during, or after the performance of agricultural task 27, which prevents the start of agricultural task 27, causes an interruption during the performance of agricultural task 27, or leads to an unsafe operating situation after the performance of agricultural task 27, the function control unit 25 is designed to issue warnings depending on the operating state. The warnings are displayed using the display device 8.

The function control unit 25 may also be configured to issue maintenance instructions based on the evaluation of the status information, regardless of the operating state. The maintenance instructions are to be understood as recommendations for maintaining the operational readiness of the working machine 1, at least one adaptation device 3, and/or the attachment 2 over the long term. The maintenance instructions are also displayed via the display device 8.

Furthermore, the function control unit 25 can be set up to monitor and document process progress independently of the operating state.

While the invention has been described and illustrated herein by references to various specific materials, procedures and examples, it is understood that the invention is not restricted to the particular combinations of material and procedures selected for that purpose. Numerous variations of such details can be implied as will be appreciated by those skilled in the art. It is intended that the specification and examples be considered as exemplary, only, with the true scope and spirit of the invention being indicated by the following claims. All references, patents, and patent applications referred to in this application are herein incorporated by reference in their entirety.

Reference List

| | | | |
|---|---|---|---|
| 1 | Autonomous work machine | BD | Image data |
| 2 | Attachment | PD | Physical Data |
| 3 | Adaptation device | UD | Environmental data |
| 4 | Sensor device | | |
| 5 | Control device | | |
| 6 | Computing unit | | |
| 7 | Storage unit | | |
| 8 | Display device | | |
| 9 | Tractor | | |
| 10 | Power lift | | |
| 11 | Lower links | | |
| 12 | Drawbar | | |
| 13 | Baler | | |
| 14 | Drive shaft | | |
| 15 | Adjustment device | | |
| 16 | Pick-up | | |
| 17 | Adjustment device | | |
| 18 | Control device | | |
| 19 | Coupling element | | |
| 20 | Coupling element | | |
| 21 | Connecting line | | |
| 22 | Connecting line | | |
| 23 | Cabin | | |
| 24 | Sensor | | |
| 25 | Functional control unit | | |
| 26 | User interface | | |
| 27 | Work assignment | | |
| 28 | Operator | | |
| 29 | Data source | | |

What is claimed is:

1. An autonomous agricultural work machine comprising at least one adaptation device for connecting an attachment to the machine and with a sensor device comprising several sensors, which is designed to determine data (BD, PD) of the autonomous work machine and the connected attachment, which comprise operating parameters of the autonomous work machine and/or the attachment, and to supply the data (BD, PD) to a control device which is designed to evaluate the data (BD, PD) determined by the sensor device, wherein the control device has a function control unit which is designed to check a respective operating state of the autonomous work machine and/or the attachment before, during, and after the performance of an agricultural task, wherein the determination of the respective operating state is based on an evaluation of status information which is based on an analysis of the data (BD, PD) provided by the sensor device before, during, and after the performance of the agricultural task.

2. The autonomous agricultural work machine according to claim 1, wherein the function control unit is designed to retrieve and take into account environmental data (UD) as status information from an external data source when determining the respective operating state.

3. The autonomous agricultural work machine according to claim 1, wherein the data provided by the sensor device comprises physical data (PD) and image data (BD) generated before, during, and after the performance of the work task.

4. The autonomous agricultural work machine according to claim 3, wherein the physical data (PD) are from the group of acoustic data, vibration data and/or torque data, throughput data, pressure data, inclination angle data and/or movement data, for the detection of which a portion of the sensors of the sensor device is configured and designed.

5. The autonomous agricultural work machine according to claim 3, wherein the image data (BD) comprise images of the machine, the at least one adaptation device, the connected attachment, and the environment, which are generated by some of the sensors of the sensor device before, during, and after the work task is performed by the machine.

6. The autonomous agricultural machine according to claim 1, wherein the function control unit is designed, before the performance of the agricultural task, to perform a function check of the sensors, the machine, the at least one adaptation device, and the attachment and/or to check the connection status of the attachment to the at least one adaptation device.

7. The autonomous agricultural work machine according to claim 6, wherein the function control unit is designed to perform a function check of connections of the at least one adaptation device, which are designed as hydraulic connections, pneumatic connections, electrical connections, and/or communication connections, after the attachment has been connected to the at least one adaptation device.

8. The autonomous agricultural work machine according to claim 1, wherein the function control unit is designed to check compliance with an operating position of the attachment and of components arranged on the attachment and/or to perform a check of an operating sequence of the attachment and of the components arranged on the attachment.

9. The autonomous agricultural work machine according to claim 8, wherein the function control unit is designed to check the operating position and/or the operating sequence by comparing it with images and/or video sequences stored in a memory unit.

10. The autonomous agricultural work machine according to claim 1, wherein the function control unit is designed to monitor the transfer of the autonomous agricultural work machine to a safe operating state and the maintenance of the safe operating state after completion of the agricultural task.

11. The autonomous agricultural work machine according to claim 10, wherein the function control unit is designed to control the machine in order to move it into a service position or a pick-up position on or at the edge of a worked or to-be-worked area as a safe operating state.

12. The autonomous agricultural work machine according to claim 1, wherein the function control unit is designed to issue warnings depending on the operating state.

13. The autonomous agricultural work machine according to claim 1, wherein the function control unit is designed to issue maintenance instructions based on the evaluation of the status information, regardless of the operating state.

14. The autonomous agricultural work machine according to claim 1, wherein the function control unit is designed to monitor and document process progress independently of the operating state.

15. The autonomous agricultural work machine according to claim 1, wherein the function control unit comprises an image evaluation module which is designed to analyze the image data (BD) using a machine learning algorithm.
